(19) United States
(12) Patent Application Publication
(10) Pub. No.: US 2016/0177453 A1
(43) Pub. Date: Jun. 23, 2016

(54) METHOD OF PHOTOPOLYMERIZING OF ACRYLATES

(71) Applicant: Deepak Shukla, Webster, NY (US)

(72) Inventor: Deepak Shukla, Webster, NY (US)

(21) Appl. No.: 15/055,657

(22) Filed: Feb. 29, 2016

Related U.S. Application Data
(63) Continuation-in-part of application No. 14/507,024, filed on Oct. 6, 2014.

(51) Int. Cl. C23C 18/16; C09D 4/00

(52) U.S. Cl. CPC C23C 18/1633; C09D 4/00

(57) ABSTRACT

Multiple photocured and copper electrolessly plated patterns are formed on a continuous flexible solid polymeric film in a roll-to-roll process. A photocurable composition is applied directly to the film in a patternwise fashion using flexographic printing members to form multiple patterns of the photocurable composition directly on the film. The photocurable composition contains an N-oxyazinium salt photoinitiator, a photosensitizer for the N-oxyazinium salt, an organic phosphite N-oxyazinium salt efficiency amplifier, an aromatic heterocyclic nitrogen-containing base, a metal seed catalyst for copper electroless plating, and one or more photocurable acrylates in designed relationships. The multiple patterns of the photocurable composition are exposed to form multiple photocured patterns directly on a product substrate and then electrolessly plated with copper to form multiple copper electrolessly plated patterns. Each electrically-conductive pattern can be incorporated into an electronic device for various purposes including touch screen displays.

### CROSS-REFERENCE TO RELATED APPLICATIONS

This application is a continuation-in-part of U.S. patent application Ser. No. 14/507,024, filed Oct. 6, 2014, which in turn is a continuation-in-part of U.S. patent application Ser. No. 12/945,994, filed Nov. 15, 2010, now abandoned.

This application is also a continuation-in-part of U.S. patent application Ser. No. 14/244,941, filed Apr. 4, 2014 (now abandoned), which also in turn is a continuation-in-part of U.S. Ser. No. 12/945,994, filed Nov. 15, 2010, now abandoned.

### FIELD OF THE INVENTION

This invention relates to a method of forming multiple photocured and copper electrolessly plated patterns in a roll-to-roll operation using a continuous flexible solid polymeric film. Such multiple copper electrolessly plated patterns are formed by applying and photocuring patterns of a photocurable composition, followed by electrolessly plating copper onto the applied and photocured patterns. Such method can be carried out in a continuous manner so that multiple copper electrically-conductive patterns can be formed on one or both sides of the continuous polymeric film and used in various electronic devices.

### BACKGROUND OF THE INVENTION

N-oxyazinium salts are known to be photoinitiators for photocrosslinking (or photocuring) and photopolymerization as described for example in U.S. Pat. Reissues 27,922 and 27,925 (both Heseltine et al.). Since most N-oxyazinium salt initiators absorb light in UV region of the electromagnetic spectrum, it is common practice to employ a photosensitizer co-initiator to increase their spectral response.

It is generally accepted that photosensitizing co-initiators function by absorption of a photon that results in excitation of an electron from an occupied molecular orbital to a higher energy, unoccupied orbital. The spin of the electron excited to the higher energy orbital corresponds to that which it exhibits in its original orbital or ground state. Thus, the photosensitizer in its initially formed excited state is in a singlet excited state. The lifetime of the singlet excited state is limited, typically less than a few nanoseconds. The excited photosensitizer can return from its singlet excited state directly to its original ground state, dissipating the captured photon energy. Alternatively, the singlet excited state photosensitizer in some instances undergoes intersystem crossing through spin inversion to another excited state, referred to as a triplet state, wherein lifetimes are typically in the microsecond to millisecond range. Since photosensitizer co-initiators that exhibit triplet states have longer lifetimes, the presence of the photosensitizer co-initiators provides a much longer time period for reaction.

GB Publication 2,083,832 (Specht et al.) describes photocurable compositions that comprise N-oxyazinium salts and co-initiators based on amino-substituted ketocoumarin triplet photosensitizers. The amino-substituted ketocoumarins exhibit very high intersystem crossing (or triplet state generation) efficiencies ranging well above 10%. U.S. Pat. No. 4,743,528 (Farid et al.) disclose a photocurable composition comprising an N-oxyazinium salt, an N-oxyazinium activator, and a photosensitizer having a reduction potential that in relation to the reduction potential of the N-oxyazinium salt activator is at most 0.1 V more positive, and an electron rich amino-substituted benzene. Similarly, U.S. Pat. No. 4,743,530 (Farid et al.) describes photocurable compositions containing an N-oxyazinium salt activator and a dye based photosensitizer with maximum absorption above 550 nm and having a reduction potential relative to that of N-oxyazinium salt activator is at most 0.1 V more positive.

N-oxyazinium salts have been demonstrated as useful sources of radicals for photoinitiating polymerization. Single electron transfer from an excited electron donor (D*) to an N-oxyazinium salt results in N—O bond cleavage and the formation of an oxy radical, as shown below in Equation (1).

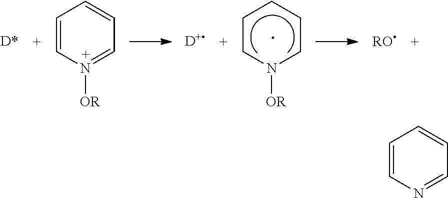

Although a number of dye-based, as well as, triplet ketocoumarin-based photosensitizing co-initiators have been used to initiate photopolymerization using N-oxyazinium salts, most of them have limited curing speed. This is usually due to overall lower quantum efficiency of the process. The quantum yield of a radiation-induced process is the number of times that a defined event occurs per photon absorbed by the system. The event could be the decomposition of a reactant molecule.

In the case of photopolymerization using N-oxyazinium salts and ketocoumarin triplet photosensitizers, the overall quantum efficiency of oxy radical generation is less than or equal to the triplet formation efficiency (the limiting quantum efficiency being defined as state efficiency for reaction times the quantum yield for formation of the reacting state). With dye-based photosensitizers, the overall quantum efficiency is expected to be even lower due to a shorter lifetime of excited dye.

To increase the overall efficiency of a photocuring process, some degree of amplification is necessary. That is, amplification of photoreactions where one photon leads to the transformation of several reactant molecules to products. In some cases, the commercial viability of certain systems can depend on whether a relatively modest amplification, for example, in the 10 to 100 times range, could be achieved. This depends usually upon limitations on exposure time, light intensity, or a combination that can be imposed on a specific use.

In most known amplified photochemical processes, amplification is based on photochemical generation of a species that is subsequently used to catalyze another reaction. Very few examples of amplified photoreactions are known where one photon leads to the transformation of several reactant molecules to products. Most of these quantum-amplified electron-transfer processes involve radical cation reactions, such as valence isomerization, for example, the transformation of hexamethyldewarbenzene to hexamethylbenzene, or the cyclization or cycloreversion between two olefin moieties and a cyclobutane, where quantum yields as high as several hundred have been obtained in polar solvents. In these reactions, the chain is propagated via electron transfer from a reactant molecule (R) to the radical cation of the product (P′⁺).

Another type of chain-amplified photoreaction involves two reactants where one is oxidized (leading, for example, to dehydrogenation) and the other is reduced. A different kind of chain reaction involving two reactants is that of onium salts. In these reactions, upon one electron reduction an onium salt (Ar—X⁺) undergoes fragmentation to yield an aryl radical, which in turn takes a hydrogen atom from an alcohol to give an α-hydroxyl radical. Chain propagation occurs through electron transfer from the α-hydroxyl radical to another onium salt molecule.

Amplified photosensitized electron transfer reactions of N-methoxypyridinium salts with alcohols of diverse structures were recently demonstrated (Shukla et al., J. Org. Chem. 70, 6809-6819.) to achieve quantum efficiencies of ˜10-20, even at modest reactant concentrations of 0.02-0.04 M, and in spite of the endothermicity of the critical electron transfer step from the intermediate α-hydroxy radical to the pyridinium salt. These reactions can be initiated by a number of singlet or triplet sensitizers, with varying degrees of initiation efficiencies that can be as high as 2.

A number of photoinitiators and photocurable compositions have been developed and commercialized to carry out free radical chain polymerization. Most known photoinitiators have only moderate quantum yields (generally less than 0.4), indicating that the conversion of light radiation to radical formation needs to be made more efficient. Thus, there are continuing opportunities for improvements in the use of photoinitiators in free radical polymerization.

In photopolymerization technology, there still exists a need for highly amplified photochemistry, and easy to prepare and easy to use photocurable compositions. The need for amplified photocurable compositions is particularly acute where absorption of light by the reaction medium may limit the amount of energy available for absorption by the photoinitiators. For example, in the preparation of color filter resists, highly pigmented resists are required for high color quality. With the increase in pigment content, the curing of color resists becomes more difficult. The same is true for the UV-photocurable inks, for example offset printing inks, which also are loaded with pigments. Hence, there is a need for a photocurable composition having a higher sensitivity and excellent resolution properties. In addition, there is a need for such photocurable compositions to meet the industrial properties such as high solubility, thermal stability, and storage stability. Such need exists even more where photocuring and pattern formation is carried out in an oxygen atmosphere of a continuous manufacturing mode, for example roll-to-roll manufacturing where manufacturing speed is important and photocuring efficiency can play a major role in achieving high production efficiency.

Thus, there is a need to provide highly efficient photocuring or photopolymerization of acrylate-containing compositions using N-oxyazinium salts in a continuous roll-to-roll process for providing multiple copper electrolessly plated patterns on a continuous web (or product substrate) without the need for inert environment or the other problems known for common photocuring operations.

### SUMMARY OF THE INVENTION

This invention provides a method for providing multiple photocured and copper electrolessly plated patterns in a roll-to-roll process, comprising:
applying a photocurable composition directly to a product substrate that is a continuous flexible solid polymeric film in a patternwise fashion using an uppermost relief surface of one or more flexographic printing members to form multiple patterns of the photocurable composition directly on the continuous flexible solid polymeric film during relative movement of the continuous flexible solid polymeric film and the uppermost relief surface of the one or more flexographic printing members to each other in the roll-to-roll process,

wherein the photocurable composition comprises an N-oxyazinium salt photoinitiator, a photosensitizer for the N-oxyazinium salt, an organic phosphite N-oxyazinium salt efficiency amplifier, aromatic heterocyclic nitrogen-containing base, a metal seed catalyst for copper electroless plating in an amount of at least 0.5 weight % based on the total weight of the photocurable composition, and one or more photocurable acrylates in an amount of at least 50 weight % based on the total weight of the photocurable composition, and

the N-oxyazinium salt photoinitiator is present in an amount of at least 0.1 weight % and up to and including 20 weight %, the photosensitizer for the N-oxyazinium salt is present in an amount of at least 0.001 weight % and up to and including 5 weight %, the organic phosphite N-oxyazinium salt efficiency amplifier is present in an amount of at least 0.1 weight % and up to and including 20 weight %, and the aromatic heterocyclic nitrogen-containing base is present in an amount of at least 0.1 weight % and up to and including 20 weight %, all based on the total weight of the one or more photocurable acrylates,
exposing the multiple patterns of the photocurable composition directly on the product substrate to photocuring electromagnetic radiation to form multiple photocured patterns directly on the product substrate in the roll-to-roll process, and
electrolessly plating the multiple photocured patterns directly on the product substrate with copper to form multiple copper electrolessly plated patterns on the product substrate in the roll-to-roll process, each copper electrolessly plated pattern having an average copper line width of less than 15 μm.

In some embodiments, this method comprises forming multiple patterns on opposing sides of the product substrate using one or more flexographic printing plates.

In addition, the method can further comprise:
forming one or more electrically-conductive articles containing one or more of the multiple copper electrolessly plated patterns.

Or, the method can further comprise:
assembling the one or more electrically-conductive articles into the same or different electronic devices.

The present invention solves some of difficulties and problems of known processes by the discovery of the use of a more efficient photocurable composition for utilizing radiation in continuous photocuring operations. The photocurable composition used in the method of the present invention provides high sensitivity and storage stability that can be useful in the continuous photocuring processes. The method can be efficiently and effectively used in roll-to-roll operations (sometimes called “roll-to-roll” processes) in which multiple copper electrolessly plated patterns are obtained.

Accordingly, the photocurable composition used in this invention can efficiently generate a reactive species with a combination of an N-oxyazinium salt photoinitiator, a photosensitizer for the N-oxyazinium salt, and an N-oxyazinium salt efficiency amplifier, which in many embodiments, is an organic phosphite that can be also referred to as a quantum yield amplifier. In some particularly useful embodiments, an aromatic heterocyclic, nitrogen-containing compound can be included to provide even greater photocuring efficiency in the continuous manufacturing operations.

One of the advantages of the present invention is that, when combined with a polymerizable material such as an acrylate, the various photoinitiator components and optionally, the aromatic heterocyclic, nitrogen-containing base cause rapid curing times in comparison to the curing times known in the prior art. For example, surprisingly, the photocurable composition used in this invention performs unexpectedly better (i.e. has higher quantum efficiency) than known N-oxyazinium salt-containing photocurable compositions, especially when multiple patterns of the photocurable composition are applied and photocured on a moving, continuous flexible product substrate (for example, a continuous solid flexible polyester film or web).

Thus, the present invention can be carried out in continuous manufacturing processes in oxygen-containing environments. Because of the high efficiency of the photocurable composition, the presence of oxygen (or oxygen inhibition) is not a serious detriment during photocuring.

In addition, because the photocuring speeds are high using the present invention, the photocurable compositions can be pigmented or used with compositions into which light penetration is limited.

### DETAILED DESCRIPTION OF THE INVENTION

### Definitions

Unless otherwise indicated, the term “photocurable composition” will refer to embodiments used in the practice of the present invention.

The term “polymerization” is used herein to mean the combining for example, by covalent bonding, of large number of smaller molecules, such as monomers, to form very large molecules, that is, macromolecules or polymers. The monomers may be combined to form only linear macromolecules or they may be combined to form three-dimensional macromolecule, commonly referred to as crosslinked polymers.

As used herein, the terms “curing” and “photocuring” mean the polymerization of functional oligomers and monomers, or even polymers, into a crosslinked polymer network. Curing is the polymerization of unsaturated monomers or oligomers in the presence of crosslinking agents.

The terms “photocurable” and “curable” refer to a material that will polymerize when irradiated for example with radiation such as ultraviolet (UV), visible, or infrared radiation in the presence of the photocurable composition. “Actinic radiation” is any electromagnetic radiation that is capable of producing photochemical action and can have a wavelength of at least 150 nm and up to and including 1250 nm, and typically at least 300 nm and up to and including 450 nm.

The terms “unsaturated monomer,” “functional oligomer,” and “crosslinking agent” are used herein with their usual meanings and are well understood by those having ordinary skill in the art.

The singular form of each component of the photocurable composition is intended also to include the plural that is, one or more of the respective components.

The term “unsaturated polymerizable material” is meant to include any unsaturated material having one or more carbon-to-carbon double bonds (ethylenically unsaturated groups) capable of undergoing polymerization. The term encompasses unsaturated monomers, oligomers, and crosslinking agents. The singular form of the term is intended to include the plural. Oligomeric and multifunctional acrylates are examples of unsaturated polymerizable materials.

The term “quantum yield” is used herein to indicate the efficiency of a photochemical process. More particularly, quantum yield is a measure of the probability that a particular molecule will absorb a quantum of light during its interaction with a photon. The term expresses the number of photochemical events per photon absorbed. Thus, quantum yields can vary from zero (no absorption) to a very large number (for example, 10³). In this context, the quantum efficiency of an N-oxyazinium salt photoinitiator is defined as in the following equation:

$$Φ = Quantum Efficiency = \frac{\# reactant alkoxyl radicals generated}{\# photons absorbed}$$

The term “photosensitizer” is meant to refer to a light absorbing compound used to induce or promote photocuring. Upon photoexcitation, the photosensitizer leads to one-electron reduction of the N-oxyazinium salt photoinitiator.

The terms “activator” and “photoinitiator” refer to an N-oxyazinium compound that accepts an electron from an excited photosensitizer, a process that leads to fragmentation of the activator to give an oxy radical that initiates polymerization.

The terms “quantum yield amplifier” and “efficiency amplifier” refer to a compound that increases the quantum efficiency of the overall photocuring or photopolymerization process.

The term “flexographic printing precursor” refers to some embodiments of elastomeric relief elements that can be used in the practice of this invention. The flexographic printing precursors include flexographic printing plate precursors, flexographic printing sleeve precursors, and flexographic printing cylinder precursors, all of which can be suitably imaged to provide a relief image in a flexographic printing member to have an average relief image depth of at least 50 μm and up to and including 1000 μm, or at least 100 μm and up to and including 600 μm, relative to the uppermost relief surface. Any desired minimum and maximum relief image depths can be achieved based on a given elastomeric relief element and the printing pattern that is desired. Flexographic printing precursors can be used to provide flexographic printing members comprising a relief image.

### Uses of the Photocurable Compositions

The present invention can be used to provide and photocure a photocurable composition in a continuous roll-to-roll process, which photocurable composition is comprised of an organic component containing polymerizable materials that are capable of crosslinking such as photocurable acrylate-containing compounds, an N-oxyazinium salt photoinitiator (or activator), a photosensitizer for the N-oxyazinium salt photoinitiator, which photosensitizer has a reduction potential that in relation to the reduction potential of the N-oxyazinium salt photoinitiator, is at most 0.1 volt more positive, an N-oxyazinium salt efficiency amplifier, an organic phosphite N-oxyazinium salt efficiency amplifier, a metal seed catalyst for copper electroless plating, and optionally an aromatic heterocyclic, nitrogen-containing base. Each of the components of the photocurable composition is described below and each of these components can be obtained from various commercial chemical suppliers. The photocurable composition and its components can be provided in any form that is suitable for the intended use.

### Photocurable Compositions

N-Oxyazinium Salt Photoinitiators:

The N-oxyazinium salt photoinitiators used in this invention are N-oxy-N-heterocyclic compounds having a heterocyclic nucleus, such as a pyridinium, diazinium, or triazinium nucleus. The N-oxyazinium salt can include one or more aromatic rings, typically carbocyclic aromatic rings, fused with the N-oxy-N-heterocyclic compound, including quinolinium, isoquinolinium, benzodiazinium, phenanthridium, and naphthodiazinium. Any convenient charge balancing counter-ion can be employed to complete the N-oxyazinium salt photoinitiators, such as halide, fluoroborate, hexafluorophosphate, and toluene sultanate. The oxy group (—O—R₁) of the N-oxyazinium compound can be selected from among a variety of synthetically convenient oxy groups. The N-oxyazinium salt photoinitiators can also be oligomeric or polymeric compounds.

The N-oxyazinium salt photoinitiator can have a reduction potential less negative than −1.4 V and comprise an N-oxy group that is capable of releasing an oxy radical when irradiated in the photocurable composition.

Representative N-oxyazinium salts are represented by the following Structure (I):

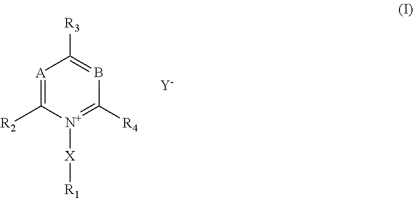

wherein A and B in Structure (I) independently represent a carbon, C—R₅, C—R₆, or nitrogen. X is oxygen (O).

R₁, R₂, R₃, R₄, R₅, and R₆ are independently hydrogen, or substituted or unsubstituted alkyl groups having 1 to 12 carbon atoms or aryl groups having 6 or 10 carbon atoms in the carbocyclic ring, which groups can be substituted with one or more acyloxy, alkoxy, aryloxy, alkylthio, arylthio, alkylsulfonyl, thiocyano, cyano, halogen, alkoxycarbonyl, aryloxycarbonyl, acetal, aroyl, alkylaminocarbonyl, arylaminocarbonyl, alkylaminocarbonyloxy, arylaminocarbonyloxy, acylamino, amino, alkylamino, arylamino, carboxy, sulfo, trihalomethyl, alkyl, aryl, heteroaryl, alkylureido, arylureido, succinimido, phthalimido groups, —CO—R₇ wherein R₇ is a substituted or unsubstituted alkyl or a substituted or unsubstituted aryl group, or —(CH═CH)ₘ—R₈wherein m is 0 or 1 and R₈ is a substituted or unsubstituted aryl group or a substituted or unsubstituted heterocyclic group.

Any of the A, B, and R groups where chemically feasible can be joined to form a ring. Y is a suitable charge balancing anion that can be a separate charged moiety or a charged part of an A, B, or R group.

Other useful N-oxyazinium salts are represented by the following Structure (II):

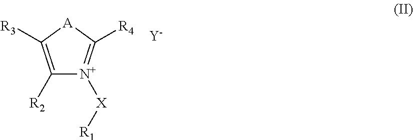

wherein A in Structure (II) represents carbon, C—R₅, nitrogen, sulfur, or oxygen with sufficient bonds and substituents to form a heteroaromatic ring. X is oxygen (O). R₁, R₂, R₃, R₄, and R₅ are independently hydrogen, or substituted or unsubstituted alkyl or aryl groups as described above for Structure (I), or any two R groups may form a ring. Y is a charge balancing anion that can be a separate charged moiety or part of a charged R group.

In some embodiments of Structures (I) and (II), R₁ is a substituted or unsubstituted alkyl group having 1 to 18 carbon atoms or a substituted or unsubstituted aryl group having 6 or 10 carbon atoms in the aromatic ring.

Other useful N-oxyazinium salt photoinitiators having a cation can be represented by the following formulae:

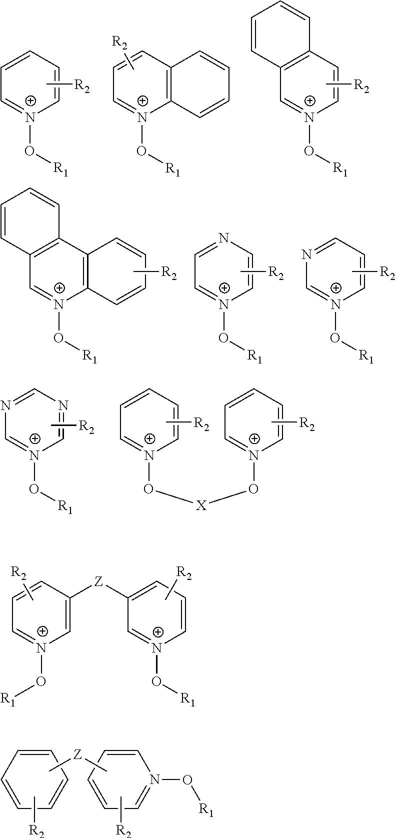

wherein R₁ represents a substituted or unsubstituted alkyl group, substituted or unsubstituted aryl group, or an acyl group, as described above, and wherein R₁ can also include a charge balancing anion, the R₂ groups independently represent hydrogen, or substituted or unsubstituted alkyl, aryl, or heteroaryl groups. Z is a substituted or unsubstituted aliphatic linking group having 1 to 12 atoms in the linking chain.

Other useful N-oxyazinium salt photoinitiators are illustrated by Structures III and IV and the compounds shown in TABLES 1 and 2 of U.S. Pat. No. 7,632,879 (Majumdar et al.) the disclosure of which is incorporated herein by reference for this teaching.

Particularly useful N-oxyazinium salt photoinitiators are compounds OZ-1 to OZ-16 identified below in TABLE I.

TABLE I

| | |
|---|---|
| 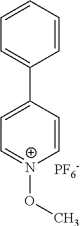 | OZ-1 |
| 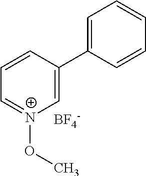 | OZ-2 |
| 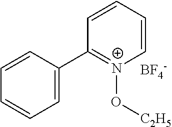 | OZ-3 |
| 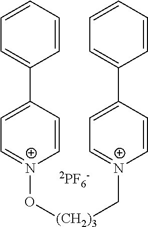 | OZ-4 |
| 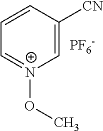 | OZ-5 |
| 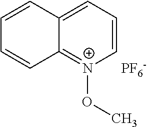 | OZ-6 |
| 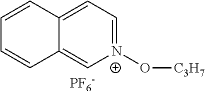 | OZ-7 |
| 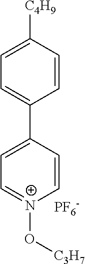 | OZ-8 |
| 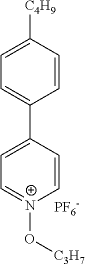 | OZ-9 |
| 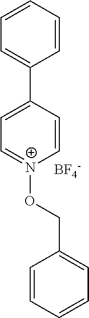 | OZ-10 |
| 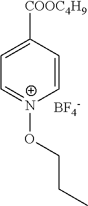 | OZ-11 |
| 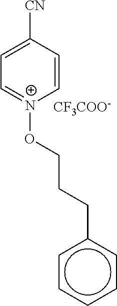 | OZ-12 |
| 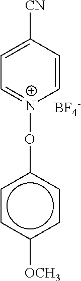 | OZ-13 |
| 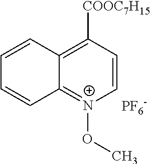 | OZ-14 |
| 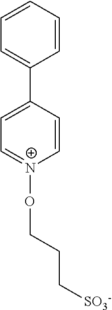 | OZ-15 |

Mixtures of N-oxyazinium salt photoinitiators can be used if desired, and the total amount of N-oxyazinium salt photoinitiators in the photocurable composition can be generally at least 10 weight %, or typically at least 40 and up to and including 80 weight % based on the total weight of N-oxyazinium salt photoinitiator, photo sensitizer for the N-oxyazinium salt photoinitiator, aromatic nitrogen-containing based (if present), and organic phosphite N-oxyazinium salt efficiency amplifier.

For example, the one or more N-oxyazinium salt photoinitiators are present in an amount of at least 6×10⁻⁷ and up to and including 6×10⁻² moles per gram of the one or more photocurable acrylates.

Photosensitizers:

The photosensitizer (S) for the N-oxyazinium salt photoinitiator initiates the reaction of the N-oxyazinium salt photoinitiator following absorption of suitable radiation having a λₘₐₓ of at least 150 and up to and including 1250 nm. The photosensitizer generally has a triplet energy of at least 20 kcal/mole of N-oxyazinium salt photoinitiator. As long as the reduction potential of the photosensitizer can be more negative than that of the N-oxyazinium salt photoinitiator (that is, it is harder to reduce), the photoinduced electron transfer reaction will be exothermic. The photoinitiated process produces the reactive oxy radical by electron transfer from the excited state of the photosensitizer (*S) to the N-oxyazinium salt photoinitiator. The oxy radical can subsequently react with the N-oxyazinium salt efficiency amplifier, such as a trialkylphosphite, producing a suitable radical such as a phosphoranyl radical that can in turn transfer an electron to the N-oxyazinium salt photoinitiator to continue the chain process. Mixtures of photosensitizers can be used if desired and the photosensitizers in the mixture can absorb at the same or different wavelengths.

Thus, the photosensitizer is capable of transferring an electron from its own lowest excited state after it has absorbed radiation. The driving force for this process depends upon: (a) the excitation energy of the sensitizer, (E^{excit})_{S}, (b) its oxidation potential, (E^{ox})_{S}, (c) the reduction potential of the N-oxyazinium salt photoinitiator, (E^{red})_{N-oxy}, and (d) an energy increment Δ that varies from near zero in polar solvents such as acetonitrile to about 0.3 eV in nonpolar media. Thus, for the photoinduced electron transfer to be exothermic (that is, for the energy stored in the excited state to exceed the energy stored in the electron transfer products) the relationships shown in the following Equation 7 should be satisfied:

(E^{excit})_{S}>(E^{ox})_{S}−(E^{red})_{N-oxy}+Δ (7)

The excitation energy of the sensitizer, (E^{excit})_{S}, could be that of the singlet or the triplet state depending on which of these states react with the N-oxyazinium salt photoinitiator.

The amount of photosensitizer used in the photocurable composition depends largely on its optical density at the wavelength(s) of radiation used to initiate the photoinduced electron transfer to an N-oxyazinium salt. Solubility of the photosensitizer in a photocurable composition can also be a factor. It is possible that the photosensitizer is a covalently bound part of a polymerizable material such as an acrylate molecule. Either a photosensitizer bound in this manner or a non-bound photosensitizer with a low extinction coefficient can be utilized at relatively high levels to help facilitate the transfer of an electron to an N-oxyazinium salt from triplet sensitizer (³S). When covalently attached to a polymeric material, the photosensitizer can comprise at least 0.01 and up to and including 10% based on the total weight of the N-oxyazinium salt photoinitiator. An example of such a covalently bound photosensitizer can be a naphthalene moiety (that absorbs actinic radiation) that can be bound to polymerizable or photocurable material, or it can be attached to an inert polymeric binder. The amount of the photosensitizers can be generally governed by their molar absorptivity or extinction coefficient. Photosensitizers that are not bound to curable compounds or polymers can be present in an amount of at least 1 and up to and including 10 weight %, based on the total weight of N-oxyazinium salt photoinitiator, photosensitizer for the N-oxyazinium salt photoinitiator, and organic phosphite N-oxyazinium salt efficiency amplifier.

For example, the total amount of one or more photosensitizers in the photocurable composition can be at least 0.001 weight % and up to and including 5 weight %, based on the total weight of the one or more photocurable acrylates in the photocurable composition.

The triplet energies of the photosensitizers used in this invention can be determined in a variety of ways. Energies for some photosensitizers or closely related analogs are disclosed in the literature. For most photosensitizers, the lowest triplet state energies can be obtained from low temperature (for example, 77° K) phosphorescence spectra. The photosensitizer can be typically dissolved in a solvent (such as ethyl acetate) or a mixture of solvents and the solution can be placed in an optical cell and immersed in liquid nitrogen. The photosensitizer can be then excited with radiation at a wavelength where it absorbs, and its phosphorescence spectrum can be measured. The highest energy absorption band (the so-called 0-0 band) in the phosphorescence spectrum can usually be taken as the energy of the lowest triplet state of the photosensitizer. For photosensitizers with weak or obscured emission or in which the ground state and lowest triplet state have substantial differences in geometry, triplet energies can be obtained either from rates of energy transfer from a series of molecules with known triplet energies or from measured equilibria with triplets of known energies. The former procedure is described in J. Amer. Chem. Soc. 102, 2152 (1980) and the latter procedure is described in J. Phys. Chem. 78, 196 (1974). In polymer matrices, photosensitizers and other compounds can occupy sites of different polarity, such that exact triplet energies are site dependent. To the extent that this is true for the photosensitizers and co-sensitizers (see below) used in this invention, the reported triplet energies represent approximate or average values.

Especially useful photosensitizers absorb visible light or near ultraviolet light, for example at a wavelength of at least 300 and up to and including 750 nm or at a wavelength of at least 300 nm and up to and including 450 nm. The ketocoumarins disclosed in Tetrahedron 38, 1203 (1982) represent one class of useful photosensitizers. The ketocoumarins described in U.K. Patent Publication 2,083,832 (Specht et al.) are also useful photosensitizers. The ketocoumarins exhibit very triplet state generation efficiencies.

Other classes of useful photosensitizers include but are not limited to, xanthones, thioxanthones, arylketones, and polycyclic aromatic hydrocarbons.

Examples of specific useful triplet photosensitizers include but are not limited to, compounds S-1 through S-10 shown below in TABLE II. The illustrated photosensitizers can optionally contain substituents as methyl, ethyl, phenyl, aryl, methoxy, and chloro groups to modify various properties such as solubility, absorption spectrum, and reduction potential.

TABLE II

| | |
|---|---|
| 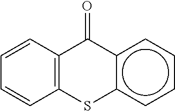 | S-1 |
| 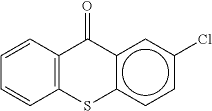 | S-2 |
| 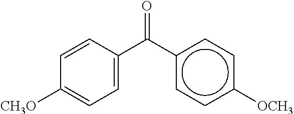 | S-3 |
| 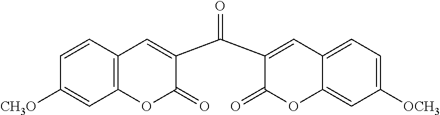 | S-4 |
| 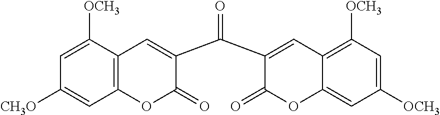 | S-5 |
| 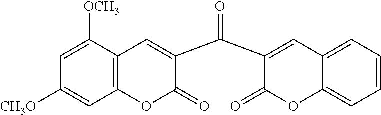 | S-6 |
| 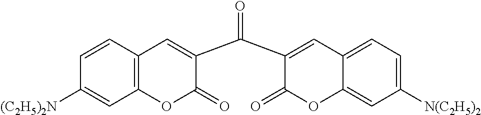 | S-7 |
| 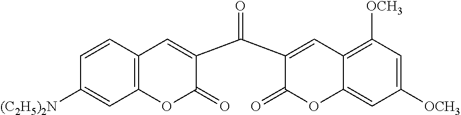 | S-8 |
| 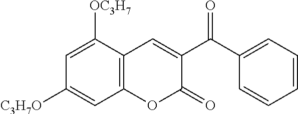 | S-9 |
| 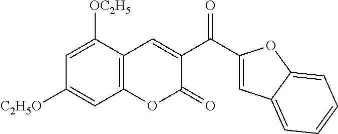 | S-10 |

In some embodiments of this invention, the photosensitizer can be a dye that by reaction with an N-oxyazinium salt photoinitiator leads to the formation of an oxy radical, which initiates polymerization. Useful classes of photosensitizer dyes can be for example, cyanine dyes, complex cyanine dyes, merocyanine dyes, complex merocyanine dyes, homopolar cyanine dyes, styryl dyes, oxonol dyes, hemioxonol dyes, hemicyanine dyes, squarilium dyes, coumarin dyes, rhodamine dyes, acridine dyes, and oxanol dyes. Representative photosensitizer dyes are also described in Research Disclosure, Item 36544, September 1996 and references cited therein. Some useful photosensitizer dyes are described in U.S. Pat. No. 4,743,530 (noted above) the disclosure of which is incorporated herein by reference. In general, any dye having a reduction potential that is at most 0.1 V more positive than the reduction potential of an N-oxyazinium salt photoinitiator can be effectively used as a photosensitizer.

Particularly useful photosensitizing cyanine or merocyanine dyes are shown by the general formulae D-1 to D-7 below in TABLE III.

TABLE III

| | |
|---|---|
| 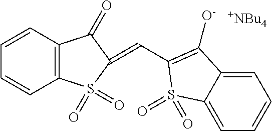 [SMILES: O=C1/C(=C/C2=C([O-])c3ccccc3S2(=O)=O)S(=O)(=O)c2ccccc21 ; "+NBu4"] | D-1 |
| 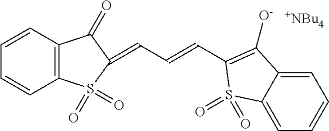 [SMILES: O=C1/C(=C/C=C/C2=C([O-])c3ccccc3S2(=O)=O)S(=O)(=O)c2ccccc21 ; "+NBu4"] | D-2 |
| 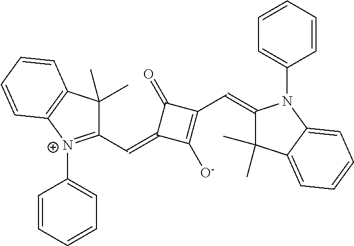 [SMILES: CC1(C)C(/C=C2\C(=O)C(/C=C3/N(c4ccccc4)c4ccccc4C3(C)C)=C2[O-])=[N+](c2ccccc2)c2ccccc21] | D-3 |
| 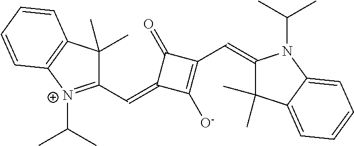 [SMILES: CC(C)N1/C(=C/C2=C([O-])C(=C/C3=[N+](C(C)C)c4ccccc4C3(C)C)/C2=O)C(C)(C)c2ccccc21] | D-4 |
| 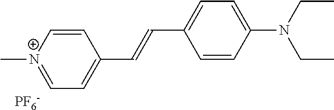 | D-5 |
| 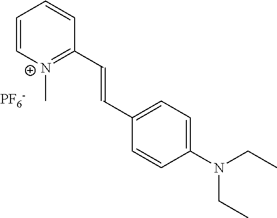 | D-6 |
| 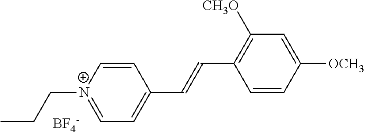 | D-7 |

N-Oxyazinium Salt Efficiency Amplifiers:

The photocurable composition used in this invention includes one or more N-oxyazinium salt efficiency amplifiers. These efficiency amplifiers are organic phosphites.

Useful organic phosphites for the present invention can be represented by the formula:

(R′O)₃P

wherein the multiple R′ groups are the same or different substituted or unsubstituted alkyl groups having 1 to 20 carbon atoms (linear, branched, or cyclic groups included), or the R′ groups can be hydrogen atoms, or two R′ groups can form a cyclic aliphatic ring or fused system.

The photocurable composition used in this invention can comprise one or more organic phosphites selected from any of trimethyl phosphite, triethyl phosphite, tripropyl phosphite, tributyl phosphite, triisobutyl phosphite, triamyl phosphite, trihexyl phosphite, trinonyl phosphite, tri-(ethylene glycol) phosphite, tri-(propylene glycol) phosphite, tri(isopropylene glycol) phosphite, tri-(butylene glycol) phosphite, tri-(isobutylene glycol) phosphite, tri-(pentylene glycol) phosphite, tri-(hexylene glycol) phosphite, tri-(nonylene glycol) phosphite, tri-(diethylene glycol) phosphite, tri-(triethylene glycol) phosphite, tri-(polyethylene glycol) phosphite, tri-(polypropylene glycol) phosphite, and tri-(polybutylene glycol) phosphite.

The N-oxyazinium salt efficiency amplifier (organic phosphite) can be present at a weight ratio to the N-oxyazinium salt photoinitiator of at least 0.001:1 and up to and including 10:1, typically of at least 0.1:1 and up to and including 5:1, or even at least 1:1 and up to and including 5:1.

Aromatic Heterocyclic, Nitrogen-Containing Bases:

The photocurable compositions used in the practice of this invention also comprise one or more bases (“basic compounds”) that are aromatic and heterocyclic in nature and comprise at least one nitrogen atom in the aromatic heterocyclic ring. Such aromatic heterocyclic nitrogen-containing bases can have nuclear aromatic heterocyclic rings that can be substituted or unsubstituted as desired with substituents. Examples of substituents are provided below. Multiple substituents can be present if desired. Many useful “bases” of this type are non-polymeric, meaning that they are compounds or molecules having a molecular weight of less than 700.

It is essential that each of these aromatic heterocyclic, nitrogen-containing bases has a pKₐ of at least 10 and up to and including 22, or more typically of at least 10 and up to and including 15, as measured in acetonitrile. An experimental method for measuring pKₐ and the pKₐ values of some aromatic heterocyclic, nitrogen-containing bases are known (for example, see Kalijurand et al. J. Org. Chem. 2005, 70, 1019).

Representative non-polymeric aromatic heterocyclic, nitrogen-containing bases useful in this invention include but are not limited to, substituted or unsubstituted, non-polymeric pyridine, quinoline, isoquinoline, imidazole, benzimidazole, benzthiazole, thiazole, oxazole, benzoxazole, 4,4′-bipyridine, pyrazine, triazine, pyrimidine, nicotinic acid, and isonicotinic acid compounds. Mixtures of these or other unnamed compounds can be used if desired, in any useful proportion. The substituted or unsubstituted non-polymeric pyridine, imidazole, or thiazole compounds are particularly useful.

When the aromatic heterocyclic, nitrogen-containing base compound (or polymeric moiety) is substituted, it can comprise, for example, one or more alkyl groups having 1 to 4 carbon atoms (linear or branched), one or more aryl groups such as substituted or unsubstituted phenyl groups, or one or more carboxyester groups wherein the ester moiety has 1 to 12 carbon atoms.

It is particularly useful to use a non-polymeric pyridine, imidazole, or thiazole compound having one or more aryl (such as phenyl), tertiary alkyl, or carboxyester substituents.

The aromatic heterocyclic, nitrogen-containing base (or mixture thereof) can be present in the photocurable composition in an amount of equal to or greater than the amount of the N-oxyazinium salt (or mixture of N-oxyazinium salts).

The useful aromatic heterocyclic, nitrogen-containing bases can be obtained from various commercial sources, or they can be prepared using known reaction conditions and starting materials.

Photocurable Acrylates:

The photocurable compositions can be used to prepare photocurable compositions by simply mixing, under “safe light” conditions, the photocurable composition, or individually, the N-oxyazinium salt photoinitiator, a photosensitizer for the N-oxyazinium salt photoinitiator, an aromatic heterocyclic, nitrogen-containing base (if present), and an organic phosphite N-oxyazinium salt efficiency amplifier, with one or more suitable photocurable acrylates.

This mixing can occur in suitable inert organic solvents if desired. Examples of suitable inert organic solvents include but are not limited to, acetone, methylene chloride, and any other inert organic solvent that does not react appreciably with the organic phosphite, N-oxyazinium salt photoinitiator, aromatic heterocyclic, nitrogen-containing base, or photosensitizer. Water is to be specifically excluded from the photocurable compositions as it will adversely affect (hydrolyze) the organic phosphites. Thus, water should be completely absent or present in an amount of less than 10⁻⁵ weight % based on the total weight of the photocurable composition.

A liquid photocurable acrylate can be used as the organic solvent for mixing, or it can be used in combination with an inert organic solvent. An inert organic solvent can be used also to aid in obtaining a solution of the materials and to provide suitable viscosity to the photocurable compositions for coatings, ink jet inks, flexographic printing inks, or other materials or operations. However, insert organic solvent-free photocurable compositions also can be prepared by simply dissolving the N-oxyazinium salt photoinitiator, the organic phosphite oxyazinium salt efficiency amplifier, an aromatic heterocyclic, nitrogen-containing base (if present), and photosensitizer in the photocurable acrylate with or without mild heating.

Photocurable acrylates can be monomers, oligomers, or polymers containing one or more acrylate groups in the molecule. Such compounds include but are not limited to, various compounds having one or more ethylenically unsaturated polymerizable groups.

In some embodiments, the photocurable acrylate also includes the photosensitizer for the N-oxyazinium salt photoinitiator in the same molecule. For example, such photosensitizers can be ketocoumarin moieties that are parts of molecules that also include acrylate groups.

The photocurable resins can have a weight average molecular weight of at least 100,000.

One or more photocurable acrylates are generally present in the photocurable composition in a total amount of at least 50 weight % and up to and including 99 weight %, or in an amount of at least 60 weight % and up to and including 90 weight %, based on the total weight of the photocurable composition.

Total N-oxyazinium salt photoinitiator concentrations in the photocurable composition can be specified in terms of weight % of N-oxyazinium salt photoinitiator based on the total weight of photocurable acrylate(s). Typical concentrations of N-oxyazinium salt photoinitiator can be at least 0.1 weight % and up to and including 20 weight %, or typically at least 0.1 weight % and up to and including 5 weight %, or more typically at least 0.5 weight % and up and including 2 weight % based on the total weight of one or more photocurable acrylates in the photocurable composition.

One or more photosensitizers can be present in the photocurable compositions in an amount of at least 0.001 weight % and up to and including 5 weight %, or of at least 0.005 weight % and up to and including 2 weight %, or more likely of at least 0.01 weight % and up to and including 1 weight %, based on the total weight of the one or more photocurable acrylates in the photocurable composition.

In addition, the organic phosphite efficiency amplifier can be present in the photocurable composition in an amount of at least 0.1 weight % and up to and including 20 weight %, or of at least 0.1 weight % and up to and including 5 weight %, or more typically of at least 0.5 weight % and up to and including 2 weight %, based on the total weight of the one or more photocurable acrylates in the photocurable composition.

One or more aromatic heterocyclic nitrogen-containing bases can be present in an amount an be at least 0.1 weight % and up to and including 20 weight %, or typically at least 0.5 weight % and up to and including 2 weight %, based on the total weight of the one or more photocurable acrylates in the photocurable composition.

The photocurable compositions described herein can include seed metal catalysts for copper electroless plating, which materials include metal-containing particles that can be pure metals, alloys, or composites of metals and inorganic or organic materials. Usually only one type of metal-containing particles are used, but it is also possible to include mixtures of metal-containing particles chosen from the same or different classes of metal-containing materials. The metal-containing particles generally have a net neutral charge.

Useful metal-containing particles include carbon-coated metal-containing particles that are composed of one or more metals (that is, pure metals or metal alloys) that are chosen from one or more classes of noble metals, semi-noble metals, Group IV metals, or combinations thereof. Useful noble metals include but are not limited to, gold, silver, palladium, platinum, rhodium, iridium, rhenium, mercury, ruthenium, and osmium. Useful semi-noble metals include but are not limited to, iron, cobalt, nickel, copper, carbon, aluminum, zinc, and tungsten. Useful Group IV metals include but are not limited to, tin, titanium, and germanium. The noble metals such as silver, palladium, and platinum are particularly useful, and the semi-noble metals of nickel and copper are also particularly useful. Tin is particularly useful in the Group IV metal class. In many embodiments, pure silver or copper particles are used. Such metal-containing particles can be at least partially surface coated with carbon. Such carbon can be amorphous, sp² hybridized, or graphene-like in nature.

Particularly useful materials are carbon-coated silver particles, carbon-coated copper particles, or in some embodiments, a mixture of carbon-coated silver particles and carbon-coated copper particles. The carbon-coated metal particles are designed to have a median diameter that is equal to or less than 0.6 μm, or less than 0.2 μm, or more likely less than 0.1 μm. Such carbon-coated metal particles generally have a minimum median diameter of 0.005 μm.

The metal-containing particles described above can be used in the photocurable composition as metal seed catalysts for copper electroless plating.

The metal-containing particles can be dispersed in various organic solvents and can have improved dispersibility in the presence of the other components. Dispersants that would be known in the art can also be present if desired. The methods used to disperse the metal particles include but are not limited to, ball-milling, magnetic stirring, high speed homogenization, high pressure homogenization, and ultrasonication, and suitable dispersing materials such as surfactants or polymers can be present in suitable amounts known in the art.

The metal-containing particles used in the present invention can be present as individual particles, but in many embodiments, they are present as agglomerations of two or more metal particles. Such metal-containing particles can be present in any geometric shape including but not limited to, spheres, rods, prisms, cubes, cones, pyramids, wires, flakes, platelets, and combinations thereof, and they can be uniform or non-uniform in shapes and sizes. The average particle size of individual and agglomerated metal-containing particles can vary from at least 0.01 μm and up to and including 25 μm, or more likely of at least 0.02 μm and up to and including 5 μm. Although the size of the metal-containing particles is not particularly limited for practice of the present invention, optimal benefits of the present invention can be achieved using metal-containing particles as individual particles or agglomerates, having an average particle size of at least 0.02 μm and up to and including 10 μm. The particle size distribution is desirably narrow as defined as one in which greater than 50%, or typically at least 75%, of the particles have a particle size in the range of 0.2 to 2 times the average particle size. The average particle size (same as mean particle size) can be determined from the particle size distribution that can be determined using any suitable procedure and equipment including that available from Coulter or Horiba and the appropriate mathematical calculations used with that equipment.

Useful metal-containing nanoparticles can be obtained from various commercial sources, or they can be derived from various metal salts or complexes and known reduction and isolation processes prior to use in the practice of this invention. Some commercial metal particles can be obtained for example from NovaCentrix (Austin, Tex.).

The described metal-containing particles useful for copper electroless plating can be present in the photocurable compositions in an amount of at least 0.5 weight % and up to and including 60 weight %, based on the total weight of the photocurable composition including any inert organic solvents.

The photocurable compositions can further comprise carbon particles or carbon black in an amount of at least 0.5 weight % and up to and including 20 weight % based on the total weight of the photocurable composition including any inert organic solvents.

Moreover, the photocurable composition used in the present invention can further comprise one or more tertiary amine-substituted benzene compounds wherein the tertiary amine can comprise the same or different alkyl groups having at least 1 carbon atom in each group or cycloalkyl groups having at least 5 carbon atoms in the carbocyclic ring. These tertiary amine-substituted benzene compounds also comprise a single para substituent having a Hammett sigma value of at least +0.2 and up to and including 1.0. Such values are reported in number of text books and articles (for example see Hansch et al., Chem Rev., 1991, 91, 165). For example, such substituents include but are not limited to, alkyl ester groups (or alkoxycarbonyl groups) wherein the alkyl group has at least 1 carbon atom (such as methyl ester, ethyl ester, and sulfonyl esters), alkylcarbonyl groups wherein the alkyl group has at least 1 carbon atom (such as acetyl), alkylsulfamoyl groups wherein the alkyl group has at least 1 carbon atoms, fluoroalkyl groups having 1 to 10 carbon atoms, nitrile, and iso-nitrile. The tertiary amine substituted benzene can also comprise a para- or meta-substituent which is an aromatic heterocycle including nitrogen containing heterocycles (for example, 4-pyridine and 2-pyridine).

Such tertiary amine-substituted benzene compounds can be present in the photocurable composition in an amount equal to or less than the amount of the organic phosphite. Best results are obtained when the tertiary amine-substituted benzene compound and organic phosphite are present in equal amounts.

Evaluation of useful components for photopolymerization or photocuring can be carried out using an acrylate-based coating formulation (see Examples below). Irradiation to initiate photocuring can be carried out using a filtered mercury lamp output through a band-pass filter. This is just one source of useful radiation. The efficiency of photocuring can be determined by the amount of photocrosslinked polymer retained after a solvent development step that leaves behind only the areas that had sufficient exposure to cause crosslinking of the photocurable acrylates.

### Methods of Using Photocurable Compositions

In general, the method of this invention can be used to provide multiple photocured electrolessly plated patterns in a roll-to-roll process.

This method can be initiated by applying a photocurable composition described herein directly to a product substrate (described below) that is a continuous flexible solid polymeric film in a patternwise fashion using an uppermost relief surface of one or more flexographic printing members to form multiple patterns of the photocurable composition directly on the continuous flexible solid polymeric film.

By “directly” is meant that no intermediate elements or webs are used to transfer the photocurable composition from the flexographic printing member to the product substrate. Each flexographic printing member is contacted directly with the product substrate that forms the “final” product article that is to be provided by the method of this invention.

Each pattern of the photocurable composition is applied to the continuous flexible solid polymer film during relative movement of that continuous flexible solid polymeric film and the uppermost relief surface of each flexographic printing member during the roll-to-roll process, for example, as the continuous flexible solid polymer film is unwound from a supply roll, moved through the various stations to provide multiple copper plated patterns, to a take up roll.

After each of the multiple patterns of the photocurable composition has been directly applied to the product substrate, each of the multiple patterns is exposed to photocuring electromagnetic radiation (described below) to form multiple photocured patterns directly on the product substrate in the roll-to-roll process. The individual photocurable patterns can be exposed individual or collectively using suitable exposure means and apparatus that would be apparent to one skilled in the art.

Following this formation of each of the multiple photocured patterns, each one is electrolessly plated while directly on the product substrate with copper to form multiple copper electrolessly played patterns directly on the product substrate in the roll-to-roll process. No intermediate transfer is carried out during any of the process functions or steps because all of the operations (for example, forming various patterns, rinsing, copper electroless plating) are carried out on the same continuous product substrate. Each copper electrolessly plated pattern generally has an average copper line width of less than 15 μm. This means that a given line can be measured in at least two places and the average of the two measurements should be less than 15 μm.

The irradiating (exposing) step can be carried out for each pattern of photocurable composition in the presence of oxygen, or it can be carried out in an inert (for example, nitrogen or argon) environment. In general, the irradiating step can be carried out using electromagnetic radiation having a wavelength of at least 150 nm or typically at least 300 nm and up to and including 1250 nm. More typically, the irradiation can be at a wavelength of at least 300 nm and up to and including 450 nm.

The photocurable composition can mixed as an organic solution in an inert organic solvent, or the photocurable composition can be mixed as an organic solution without an insert organic solvent, but using at least one photocurable acrylate as the solvent. As noted above, water is excluded from these organic solvents.

Useful relief printing member (for example, flexographic printing member) for forming each of the multiple patterns on the product substrate have a relief layer comprising an uppermost relief surface and an average relief image depth (pattern height) of at least 50 μm, or typically having an average relief image depth of at least 100 μm relative from the uppermost relief surface, can be prepared from imagewise exposure of an elastomeric photopolymerizable layer in an relief printing member precursor such as a flexographic printing member precursor, for example as described in U.S. Pat. No. 7,799,504 (Zwadlo et al.) and U.S. Pat. No. 8,142,987 (Ali et al.) and U.S. Patent Application Publication 2012/0237871 (Zwadlo), the disclosures of which are incorporated herein by reference for details of such precursors. Such elastomeric photopolymerizable layers can be imaged through a suitable mask image to provide an elastomeric relief element (for example, flexographic printing plate or flexographic printing sleeve). In some embodiments, the relief layer comprising the relief pattern can be disposed on a suitable substrate as described in the noted Ali et al. patent. Other useful materials and image formation methods (including development) for provide elastomeric relief images are also described in the noted Ali et al. patent.

In other embodiments, the relief printing member can be provided from a direct (or ablation) laser-engraveable relief printing member precursor, with or without integral masks, as described for example in U.S. Pat. No. 5,719,009 (Fan), U.S. Pat. No. 5,798,202 (Cushner et al.), U.S. Pat. No. 5,804,353 (Cushner et al.), U.S. Pat. No. 6,090,529 (Gelbart), U.S. Pat. No. 6,159,659 (Gelbart), U.S. Pat. No. 6,511,784 (Hiller et al.), U.S. Pat. No. 7,811,744 (Figov), U.S. Pat. No. 7,947,426 (Figov et al.), U.S. Pat. No. 8,114,572 (Landry-Coltrain et al.), U.S. Pat. No. 8,153,347 (Veres et al.), U.S. Pat. No. 8,187,793 (Regan et al.), and U.S. Patent Application Publications 2002/0136969 (Hiller et al.), 2003/0129530 (Leinenback et al.), 2003/0136285 (Telser et al.), 2003/0180636 (Kanga et al.), and 2012/0240802 (Landry-Coltrain et al.).

As noted above, average relief image depth (relief pattern) or an average relief pattern height in the relief pattern is at least 50 μm or typically at least 100 μm relative to the uppermost relief surface. A maximum relief image depth (relief pattern) or relief pattern height can be as great as 1,000 μm, or typically up to and including 750 μm, relative to the uppermost relief surface.

Thus, a method of this invention can utilize a flexographic printing member as described above to print multiple patterns of the photocurable composition on the product substrate. The present invention enables printing of a variety of photocurable compositions over relatively large areas with desirable resolution (for example, a line width of less than 15 μm). In some embodiments, the resolution (line width) can be as low as 5 μm or even as low as 1 μm. The method of this invention can be adapted to high-speed production processes for the fabrication of multiple electrically-conductive copper patterns that can be assembled into the same or different electronic devices and components, such as individual touch screen displays in various electronic devices.

The photocurable composition can be applied in a suitable manner to the uppermost relief surface (raised surface) in each flexographic printing members. It is desirable that as much as possible of the photocurable composition is applied predominantly to the uppermost relief surface. Anilox roller systems or other roller application systems, especially low volume Anilox rollers, below 2.5 billion cubic micrometers per square inch (6.35 billion cubic micrometers per square centimeter) and associated skive knives are used in flexographic printing presses are particularly advantageous for this application of the photocurable composition. Optimum metering of the printable material composition onto the uppermost relief surface only can be achieved by controlling the photocurable composition viscosity or thickness, or choosing an appropriate application means.

The photocurable composition can have a viscosity during this application of at least 1 cps (centipoise) and up to and including 1000 cps.

The photocurable composition can be applied at any time after the relief image is formed within a flexographic printing member. As noted above, the photocurable composition can be applied by any suitable means, including the use of an Anilox roller system, which can be one of the most useful ways for application to the uppermost relief surface. The thickness of the photocurable composition on the relief image is generally limited to a sufficient amount that can readily be transferred to a product substrate but not too much to flow over the edges of the flexographic printing member in the recesses.

A continuous flexible solid polymeric film is provided as a product substrate on which desired multiple patterns of a photocurable compositions are formed using one or more flexographic printing members. This product substrate can be composed of any suitable polymeric material (or laminates of polymeric materials, laminates of polymeric materials and metals, or laminates of polymeric materials and papers, as long as the patterns are formed on a polymeric surface). The multiple patterns are formed on at least one receptive surface of the continuous flexible solid polymeric film or on both receptive surfaces (opposing surfaces) thereof. The substrate can be transparent or opaque, and rigid or flexible. A receptive surface of the product substrate can be treated for example with a primer layer or electrical or mechanical treatments (such as graining) to render that surface more “receptive” to achieve suitable adhesion of the photocurable composition. The product substrate is not porous or membrane-like. Thus, it is not a membrane web like the polymer membrane described in U.S. Pat. No. 7,316,794 (O'Brien) formed from a membrane forming solution or dispersion onto which a pattern is transferred from a temporary substrate during a drying process. The product substrate used in the present invention is not a temporary substrate nor a polymer membrane as described in this reference. Rather, the product substrate is the only support or substrate material used in the present invention.

In some embodiments, the product substrate comprises a separate receptive layer as the receptive surface disposed on a continuous flexible solid support material, which receptive layer and support material can be composed of a material such as a suitable polymeric material that is highly receptive of the photocurable composition. Such receptive layer generally has a dry thickness of at least 0.05 μm and up to and including 10 μm, or typically of at least 0.05 μm and up to and including 3 μm, when measured at 25° C.

A polymeric surface of the product substrates can be treated by exposure to corona discharge, mechanical abrasion, flame treatments, or oxygen plasmas, or by coating with various polymeric films, such as poly(vinylidene chloride) or an aromatic polysiloxane as described for example in U.S. Pat. No. 5,492,730 (Balaba et al.) and U.S. Pat. No. 5,527,562 (Balaba et al.) and U.S. Patent Application Publication 2009/0076217 (Gommans et al.), to make that receptive surface even more receptive to the photocurable composition.

Suitable product substrate materials include but are not limited to, solid transparent polyester films such as poly(ethylene terephthalate) films and poly(ethylene naphthalate) films, polyimide films, polycarbonate films, polyacrylate films, polystyrene films, polyolefin films, polyamide films, resin-coated papers, and other flexible, solid (nonporous) materials that would be readily apparent to one skilled in the art.

Particularly useful product substrates are polyesters films such as poly(ethylene terephthalate), polycarbonates, or poly(vinylidene chloride) films that have been surface-treated as noted above, or coated with one or more suitable adhesive or subbing layers, the outer layer being receptive to the photocurable composition.

Useful product substrates can have a desired dry thickness depending upon their eventual uses, for example their incorporation into various articles or devices (for example as touch screens). For example, the dry thickness of the product substrate can be at least 0.001 mm and up to and including 10 mm, or typically at least 0.008 mm and up to and including 0.2 mm.

A transfer pressure can be applied to either the flexographic printing member or the product substrate to assure contact and complete transfer of the photocurable composition to the product substrate. For example, transfer of the photocurable composition can be carried out by moving the uppermost relief surface of the flexographic printing member relative to the product substrate, by moving the product substrate relative to the uppermost relief surface of the relief printing member, or by relative movement of both elements to each other. The transfer can be automated such as by example, carrying the product substrate using a conveyor belt, directly driven moving fixtures, chain, belt, or gear-driven fixtures, frictional roller, printing press, or rotary apparatus, or any combination of these methods, in a continuous roll-to-roll process so that the final product having the photocured copper electrolessly plated patterns can be taken up in roll form or each of the patterns can be cut out of the continuous product substrate to a desired size and individually used for a desired purpose.

The product substrate and flexographic printing member can be kept in contact to form each of the multiple patterns for as little as 10 milliseconds and up to and including 10 seconds or even up to and including 60 seconds, but in the desired continuous roll-to-roll process, the contact is designed to be as short a time as possible. Once the desired contact is completed, the flexographic printing member is separated from the product substrate to leave each desired pattern of the photocurable composition on the product substrate. At least 70 weight % of the photocurable composition that was originally disposed on the uppermost relief surface of the flexographic printing member (using one or more applications of photocurable composition) can be transferred to the product substrate in each pattern.

Separation of the flexographic printing member and the product substrate can be accomplished using any suitable means including but not limited to, manual peeling apart, impingement of gas jets or liquid jets, or mechanical peeling devices.

The present invention can use multiple flexographic printing plates (for example, prepared as described above) in a stack in a printing station wherein each stack has its own printing plate cylinder so that each flexographic printing plate is used to print multiple patterns on the product substrate (on one or both supporting sides). The same or different photocurable composition can be “printed” or applied to such product substrate (on same or opposing supporting sides) using the multiple flexographic printing plates.

In other embodiments, a central impression cylinder can be used with a single impression cylinder (as a flexographic printing member) mounted on a printing press frame. As the product substrate enters the printing press frame, it is brought into contact with the impression cylinder and the appropriate pattern is formed with the photocurable composition. Alternatively, an in-line flexographic printing process can be utilized in which the printing stations are arranged in a horizontal line and are driven by a common line shaft. The printing stations can be coupled to exposure stations, cutting stations, folders, and other post-processing equipment. A skilled worker could readily determine other useful configurations of equipment and stations using information that is available in the art. For example, an in-the-round imaging process is described in WO 2013/063084 (Jin et al.).

In general, transferring the photocurable composition from the raised uppermost relief surface of the flexographic printing member to the product substrate creates each pattern of the photocurable composition on the product substrate to be cured as described below. The transferring can be referred to as “printing” (or lamination or embossing). Each printed pattern of the photocurable composition on the product substrate can comprise lines, solid areas, dots, or a mixture of lines and solid areas in any desired pattern that text, numbers, shapes, or other images, or combinations thereof. In general, the average line width for printed lines in a pattern on the product substrate can be less than 20 μm or even less than 15 μm and as wide as 2 μm. Such lines can also have an average height of at least 10 nm and up to and including 4,000 μm. These average dimensions can be determined by measuring the lines in at least 10 different places and determining the width or height using known image analysis tools including but not limited to, profilometry, optical microscopic techniques, atomic force microscopy, and scanning electron microscopy.

The method of this invention provides multiple printed patterns of fine lines of a photocurable composition that, after curing, contain a seed metal catalyst material for a subsequent copper electroless plating process. For example, such seed metal catalyst materials include but are not limited to, metals such as palladium, tin, nickel, platinum, iridium, rhodium, and silver, or a mixture of tin and palladium, as well as other metal-containing particles described above. Such seed metal catalyst materials can be incorporated into the photocurable composition in amounts that would be readily apparent to one skilled in the art.

The product substrate carrying the multiple photocured patterns can be immediately immersed in an aqueous-based electroless metal plating bath or solution, or it (for example as rolled up continuous web) can be stored with the multiple photocured pattern(s) for copper electroless plating at a later time.

In most continuous operations, the product substrate carrying the multiple photocured patterns is contacted with a copper electroless plating bath or solution that contains copper in an amount of at least 0.01 weight % and up to and including 20 weight % based on total solution weight.

Copper electroless plating can be carried out using known temperature and time conditions, as such conditions are well known in various textbooks and scientific literature. It is also known to include various additives such as metal complexing agents or stabilizing agents in the copper electroless plating solutions. Variations in time and temperature can be used to change the copper electroless plating thickness or the copper electroless plating deposition rate.

A useful copper electroless plating solution or bath is an electroless copper(II) plating bath that can contain formaldehyde as a reducing agent. Ethylenediaminetetraacetic acid (EDTA) or salts thereof can be present as a copper complexing agent. For example, copper electroless plating can be carried out at room temperature for several seconds and up to several hours depending upon the desired deposition rate and plating rate and plating metal thickness.

After the copper electroless plating procedure to provide multiple electrically-conductive copper patterns on one or more portions of one or opposing supporting sides of the product substrate, the resulting product article can be removed from the copper electroless plating bath or solution and can be washed using distilled water or deionized water or another aqueous-based solution to remove any residual copper electroless plating chemistry. At this point, the electrolessly plated copper is generally stable and the multiple copper patterns can be used for their intended purpose to form various electrically-conductive articles with desired electrically-conductive copper grid lines or electrically-conductive metal connector (or BUS connectors or electrodes).

In some embodiments, the resulting product article can be rinsed or cleaned with water at room temperature as described for example in [0048] of US 2014/0071356 (Petcavich), or with deionized water at a temperature of less than 70° C. as described in [0027] of WO 2013/169345 (Ramakrishnan et al.).

To change the surface of the electroless plated copper for visual or durability reasons, it is possible that a variety of post-treatments can be employed including surface plating of at least another metal such as nickel or silver on the electrolessly plated copper (this procedure is sometimes known as “capping”), or the creation of a metal oxide, metal sulfide, or a metal selenide layer that is adequate to change the surface color and scattering properties without reducing the conductivity of the electrolessly plated (second) metal. Depending upon the metals used in the various capping procedures of the method, it may be desirable to treat the electrolessly plated copper with another seed metal catalyst in an aqueous-based seed metal catalyst solution to facilitate deposition of additional metals.

In addition, multiple treatments with an aqueous-based electroless copper plating solution can be carried out in sequence, using the same or different conditions. Sequential washing or rinsing steps can be also carried out where appropriate at room temperature or a temperature less than 70° C.

Further, the copper electroless plating procedures can be carried out multiple times, in sequence, using the same or different electroless plating metal and the same or different electroless plating conditions.

Some details of useful methods and apparatus for carrying out some embodiments of the present invention are described for example in US 2014/0071356 (noted above) and WO 2013/169345 (noted above). Other details of a useful manufacturing system for preparing electrically-conductive articles especially in a roll-to-roll manner are provided in PCT/US/062366 (filed Oct. 29, 2012 by Petcavich and Jin), the disclosure of which is incorporated herein by reference.

An additional system of equipment and step features that can be used in carrying out the present invention is described in U.S. Patent Application Publication 2015/0191006 (Shifley), the disclosure of which is incorporated herein by reference for any details that are pertinent to use of the present invention.

On at least a first portion of the product substrate described herein, the method comprises forming a first photocurable pattern of a photocurable composition (as described herein) using a flexographic printing member. The first photocurable pattern is then photocured to form a first photocured pattern on the first portion of the product substrate, which first photocured pattern comprises dispersed metal seed catalyst for copper electroless plating. Such first photocured pattern can then be copper electrolessly plated on the first portion of the product substrate (as described above).

This method can further comprise:
carrying out the pattern forming, photocuring, and copper electrolessly plating features described above one or more additional times on one or more additional portions of the product substrate that are different from the first portion, using the same or different photocurable composition. In such manner, multiple photocured and copper electrolessly plated patterns can be formed on the same or different supporting sides of the product substrate. The resulting copper electrically-conductive patterns can be the same in composition, pattern, or electrical-conductivity, or they can be all different (as predetermined from customer needs) in any or all of these features.

Thus, the method can be used to provide a plurality of articles, comprising:
forming a first photocurable pattern on a first portion of the product substrate by applying a photocurable composition to the first portion using a flexographic printing member,
advancing the product substrate comprising the first photocurable pattern to be proximate exposing electromagnetic radiation, and thereby forming a first photocured pattern on the first portion,
forming a second photocurable pattern on a second portion of the product substrate by applying the same or different photocurable composition to the second portion using the same or different flexographic printing member,
advancing the product substrate comprising the second photocurable pattern to be proximate exposing electromagnetic radiation, and thereby forming a second photocured pattern on the second portion,
optionally, forming one or more additional photocured patterns in a similar manner on one or more additional respective portions of the product substrate using the same or different photocurable composition and the same or different flexographic printing member, and
winding up the continuous web comprising multiple photocured patterns, or using the continuous web immediately for further processing such as copper electrolessly plating.

Thus, the method can also comprise:
forming multiple electrically-conductive articles from the product substrate comprising multiple photocured patterns, and
assembling the one or more electrically-conductive articles into the same or different electronic devices (such as the same or different touch screen displays or devices).

Such method can also comprise:
copper electrolessly plating each of the multiple photocured patterns in the product substrate to form multiple electrically-conductive articles, which can be assembled into the same or different electronic devices by the same or different user. Such electronic devices can include a touch screen or other display that also include suitable controllers, housings, and software for any type of desired communication via the internet. Alternatively, the electronic devices can be sub-components of such touch screen or other display devices.

Useful product articles prepared according using the present invention can be formulated into capacitive touch screen sensors that comprise suitable patterns of electrically-conductive copper grid lines, electrically-conductive copper connectors (electrical leads or BUS connectors). For example, the patterns of electrically-conductive copper grid lines and electrically-conductive copper connectors can be formed by printing the photocurable composition described herein as predetermined patterns, followed by photocuring and copper electrolessly plating the printed patterns as described above.

The following Experiments 1-3 demonstrate the effect of various components on reaction (photocuring) efficiency in solution. Such information was helpful to discover the present invention.

### Experiment 1

### Quantum Yield of 2-chlorothioxanthone (S-2) Photosensitized Reaction of N-methoxy-4-phenylpyridinium Hexafluorophosphate (OZ-1) in Acetonitrile-d₃

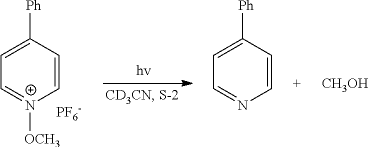

The 2-chlorothioxanthone (S-2) (0.002 mole) sensitizer was added to a 3 ml solution of 0.02 molar N-methoxy-4-phenylpyridinium hexafluorophosphate (OZ-1) in acetonitrile-d₃. In a 1×1 cm quartz cell, this solution was purged with a thin stream of argon for 2-3 minutes and then irradiated at 405 nm for 5 minutes. Argon or nitrogen was continuously passed through the reaction mixture during photolysis to purge as well as stir the solution. After photolysis, a ¹H NMR spectrum of the photolysate was recorded and the percent conversion of the starting materials was determined by integration of diagnostic signals. For example, before photolysis the ¹H NMR spectrum of a solution of N-methoxy-4-phenylpyridinium hexafluorophosphate and a catalytic amount of 2-chlorothioxanthone in acetonitrile-d₃ shows characteristic signals due to the N-methoxypyridinium salt OZ-1 [δ: 8.94 (m, 2H), 8.35 (m, 2H), 7.94 (m, 2H), 7.69 (m, 3H), and 4.43 (s, 3H)]. After irradiation at 405 nm for about 2 minutes, the ¹H NMR spectrum of the photolysate clearly showed appearance of new diagnostic signals due to formation of 4-phenylpyridine [δ: 8.71 (m, 2H) and 8.26 (m, 2H) and CH₃OH (δ: 3.30)]. The identity of these products was established by comparison with ¹H NMR spectra of authentic samples. The yields of the photo-products were determined from quantitative integration of diagnostic signals of starting materials, N-methoxy-4-phenylpyridinium (OZ-1), and product, 4-phenylpyridine, in NMR spectra of the reaction mixtures. Conversions were kept between 15-20% to minimize any secondary photolysis of the products. The photon flux at the excitation wavelengths, 405 nm, was determined by using the known photocycloaddition reaction of phenanthrenequinone to trans-stilbene in benzene as an actinometer (Bohning, J. J.; Weiss, K. J. Am. Chem. Soc. 1966, 88, 2893.). The light intensity was within 7-10×10⁻⁸ Einsteins min⁻¹. The quantum yield of reaction was determined by dividing the moles of photoproduct formed by total light intensity and is shown below in TABLE IV.

### Experiment 2

### Amplified Quantum Yield of 2-chlorothioxanthone (S-2) Photosensitized Reaction of N-methoxy-4-phenylpyridinium Hexafluorophosphate (OZ-1) and Triethylphosphite in Acetonitrile-d₃

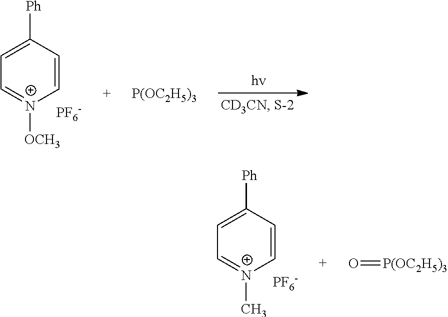

The 2-chlorothioxanthone (S-2) (0.002 mole) sensitizer was added to a 3 ml solution of 0.02 molar N-methoxy-4-phenylpyridinium hexafluorophosphate (OZ-1) and 0.02 molar triethylphosphite in acetonitrile-d₃. In a 1×1 cm quartz cell, this solution was purged with a thin stream of argon for 2-3 minutes and then irradiated at 405 nm for 30 seconds. Argon or nitrogen was continuously passed through the reaction mixture during photolysis to purge as well as stir the solution. After photolysis, ¹H NMR spectrum of the photolysate was recorded and the percent conversion of the starting materials was determined by integration of diagnostic signals. Before photolysis, the ¹H NMR spectrum of an solution of OZ-1, triethylphosphite and a catalytic amount of 2-chlorothioxanthone in acetonitrile-d₃ shows characteristic signals due to the N-methoxypyridinium salt (δ: 8.94 (m, 2H), 8.35 (m, 2H), 7.94 (m, 2H), 7.69 (m, 3H), and 4.43 (s, 3H)), triethylphosphite ((δ: 3.84 (quintet, 6H), 1.23 (t, 9H)). After irradiation at 405 nm for about 30 seconds, the ¹H NMR spectrum of the photolysate clearly showed appearance of new diagnostic signals due to formation of 4-phenylpyridine (δ: 8.71 (m, 2H) and 8.26 (m, 2H) and triethylphosphite (δ: 4.06 (quintet, 6 H) and 1.30 (t, 9H)), N-methyl-4-phenylpyridinium (δ: 4.30 (s, 3 H)). The identity of these products was established by comparison with ¹H NMR spectra of authentic samples. The yields of the photoproducts were determined from quantitative integration of ¹H NMR spectra of the reaction mixtures containing products N-methyl-4-phenylpyridinium signal at δ: 4.30 relative to starting material N-methoxy signal of OZ-1 at δ: 4.43, as well as signals due to product triethylphosphate at δ: 4.06 relative to starting material triethylphosphite at δ: 3.84. Conversions were kept between 15-20% to minimize any secondary photolysis of the products. The photon flux at the excitation wavelengths, 405 nm, was determined by using the known photocycloaddition reaction of phenanthrenequinone to trans-stilbene in benzene as an actinometer (Bohning, J. J.; Weiss, K. J. Am. Chem. Soc. 1966, 88, 2893.). The light intensity was within 7-10×10⁴ Einsteins min⁻¹. The quantum yield of reaction was determined by dividing the moles of photoproducts formed by total light intensity and is shown below in TABLE IV.

### Experiment 3

The composition described above for Experiment 2 was formulated but 0.02 molar of 4-phenylpyridine was added as an aromatic heterocyclic, nitrogen-containing base having a pKₐ of at least 10 and up to and including 22 in acetonitrile. The quantum yield of reaction was determined by dividing the moles of photoproducts formed by total light intensity and is shown below in TABLE IV.

TABLE IV
Reaction of Triplet Sensitized Reaction of N-Oxyazinium
Salts with and without Phosphite: Effect of Concentration
of N-Oxyazinium on Quantum Yields.

| | | Amount of | Quantum |
|---|---|---|---|
| Photocurable Composition | | Triethylphosphite | Yield |
| Experiment 1 | 0.002 molar S-2 + | 0 | 0.95 |
| | 0.02 molar OZ-1 | | |
| Experiment 2 | 0.002 molar S-2 + | 0.02 molar | 30.0 |
| | 0.02 molar OZ-1 | | |
| Experiment 3 | 0.002 molar S-2 + | 0.02 molar | 75 |
| | 0.04 molar OZ-1 + | | |
| | 0.02M 4-phenylpyridine | | |

The data in TABLE IV clearly show that the quantum yields of reaction of N-oxyazinium salt OZ-1, by photoinduced electron transfer from S-2, are greatly amplified in the presence of the added triethylphosphite in Experiment 2 relative to Experiment 1 when no triethylphosphite was added. However, much greater quantum yield (or quantum efficiency) was achieved using the composition of Experiment 3 that also contained the aromatic heterocyclic, nitrogen-containing base, 4-phenylpyridine.

The following Examples show the effect of the added photoinitiator efficiency amplifier, that is an organic phosphite, on the overall quantum yield of decomposition of N-oxyazinium salt via photoinduced electron transfer from a photosensitizer.

### Comparative Example 1

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (0.1 weight % based on total weight of photocurable acrylates) and 4-phenyl-N-methoxypyridinium hexafluorophosphate N-oxyazinium salt OZ-1 (0.4 weight % based on total weight of photocurable acrylates) were added and dissolved at room temperature. Each photocurable composition was then coated onto a glass plate and exposed to 405 nm radiation in air. After this irradiation, the samples were washed with acetone and the photocuring efficiency was measured in terms of the amount of crosslinked polymer left. The results are summarized in TABLE V below.

### Comparative Example 2

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (0.01 weight % based on total weight of photocurable acrylates) and 4-phenyl-N-methoxypyridinium hexafluorophosphate N-oxyazinium salt OZ-1 (0.4 weight % based on total weight of photocurable acrylates) were added and dissolved at room temperature. The mixture was split in two equal parts and in a second part, triethylphosphite efficiency amplifier (0.6 weight % based on total weight of photocurable acrylates) was added. The photocurable composition was then coated onto a glass plate and exposed to 405 nm radiation in air. After irradiation, the sample was washed with acetone and the cure efficiency measured in terms of the amount of crosslinked polymer left. The results are summarized below in TABLE V.

TABLE V
Effect of Efficiency Phosphite on Photocuring in Air

| | | Material left after |
|---|---|---|
| Photocurable Composition | Degree of Curing | Solvent Wash? |
| Comparative Example 1 | No | No |
| Comparative Example 2 | Extensive curing | Yes |

These results clearly show that in the presence of the efficiency amplifier phosphite (Comparative Example 2), photocuring of the photocurable composition was extensive relative to Comparative Example 1.

The following Examples compare the photocuring speed of a photocurable composition containing no efficiency amplifier trialkylphosphite, a photocurable composition comprising a trialkylphosphite, a photocurable composition comprising a trialkylphosphite in combination with an aromatic heterocyclic nitrogen-containing base, and a photocurable composition comprising a trialkylphosphite, an aromatic heterocyclic nitrogen-containing base, and a tertiary amine containing benzene compound.

### Comparative Example 3

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (0.01 weight % based on total weight of photocurable acrylates) and 4-phenyl-N-methoxypyridinium hexafluorophosphate N-oxyazinium salt OZ-1 (0.4 weight % based on total weight of photocurable acrylates) were added and dissolved at room temperature. The photocurable composition was then coated onto a glass plate and exposed to 405 nm radiation under N₂. After irradiation, the sample was washed with acetone and cure efficiency measured in terms of the amount of crosslinked polymer left. The results are summarized below in TABLE VI.

### Comparative Example 4

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (0.1 weight % based on total weight of photocurable acrylates) and 4-phenyl-N-methoxypyridinium hexafluorophosphate N-oxyazinium salt OZ-1 (0.4 weight % based on total weight of photocurable acrylates) were added and dissolved at room temperature and triethylphosphite efficiency amplifier (0.5 weight % based on total weight of photocurable acrylates) was added to the formulation. The photocurable composition was then coated onto a glass plate and exposed to 405 nm radiation under N₂. After irradiation, the sample was washed with acetone and the cure efficiency was measured in terms of the amount of crosslinked polymer left. The results are summarized below in TABLE VI.

TABLE VI
Effect of Efficiency Amplifier Triethylphosphite on Cure Speed

| | Dose Required for |
|---|---|
| Photocurable Composition | Complete Photocuring |
| Comparative Example 3 | 120 mJ/cm² |
| OZ-1 + S-2 | |
| Comparative Example 4 | 15 mJ/cm² |
| OZ-1 + S-2 + Triethylphosphite | |

These results clearly show that in the use of the efficiency amplifier (Comparative Example 4) provided quite rapid photocuring of the photocurable composition (by a factor of 8) relative to the photocurable composition used in Comparative Example 3.

### Invention Example 1

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (0.01 weight % based on total weight of photocurable acrylates) and 4-phenyl-N-methoxypyridinium hexafluorophosphate N-oxyazinium salt OZ-1 (0.4 weight % based on total weight of photocurable acrylates) were added and dissolved at room temperature. Triethylphosphite efficiency amplifier (0.5 weight % based on total weight of photocurable acrylates) and 4-phenylpyridine (0.5 weight % based on total weight of photocurable acrylates) were then added to the formulation. The resulting photocurable composition was then coated onto a glass plate and exposed to 405 nm radiation under N₂. After irradiation, the sample was washed with acetone and the cure efficiency was measured in terms of the amount of crosslinked polymer left. The results are summarized below in TABLE VII.

TABLE VII
Effect of Aromatic Heterocyclic, Nitrogen-
containing Base on Cure Speed

| | Dose Required for |
|---|---|
| Photocurable Composition | Complete Photocuring |
| Comparative Example 4 | 15 mJ/cm² |
| OZ-1 + S-2 + Triethylphosphite | |
| Invention Example 1 | 8 mJ/cm² |
| OZ-1 + S-2 + Triethylphosphite + | |
| 4-Phenylpyridine | |

These results clearly show that use of an aromatic heterocyclic, nitrogen-containing base in conjunction with the efficiency amplifier phosphite (Invention Example 1) provided an enhanced photocuring rate (by a factor of 2) relative to the photocurable composition used in Comparative Example 4.

### Invention Example 2

To a mixture of multifunctional acrylates (10 g, 8:2 by weight mixture of polyethylene glycol 200 diacrylate (SR259) and dipentaerythritol pentaacrylate ester (SR399) (both from Sartomer), 2-chlorothioxanthone photosensitizer S-2 (0.1 weight % based on total weight of photocurable acrylates) and 4-phenyl-N-methoxypyridinium hexafluorophosphate N-oxyazinium salt OZ-1 (0.04 weight % based on total weight of photocurable acrylates) were added and dissolved at room temperature. Triethylphosphite efficiency amplifier (0.5 weight % based on total weight of photocurable acrylates), a tertiary amine ethyl-4-dimethylamino benzoate (EDAB, 0.5 weight % based on total weight of photocurable acrylates) and 4-phenylpyridine (1 weight % based on total weight of photocurable acrylates) were then added to the formulation. The resulting photocurable composition was then coated onto a glass plate and exposed to 405 nm radiation under N₂. After irradiation, the sample was washed with acetone and the cure efficiency was measured in terms of the amount of crosslinked polymer left. The results are summarized below in TABLE VIII.

TABLE VIII
Effect of Various Photocurable Compositions on Curing Speed

| | Dose Required for |
|---|---|
| Photocurable Composition | Complete Photocuring |
| Comparative Example 4 | 15 mJ/cm² |
| OZ-1 + S-2 + Triethylphosphite | |
| Invention Example 1 | 8 mJ/cm² |
| OZ-1 + S-2 + Triethylphosphite + | |
| 4-Phenylpyridine | |
| Invention Example 2 | 2 mJ/cm² |
| OZ-1 + S-2 + Triethylphosphite + | |
| 4-Phenylpyridine + EDAB | |

The invention has been described in detail with particular reference to certain preferred embodiments thereof, but it will be understood that variations and modifications can be effected within the spirit and scope of the invention.

1. A method for providing multiple photocured and copper electrolessly plated patterns in a roll-to-roll process, comprising:
applying a photocurable composition directly to a product substrate that is a continuous flexible solid polymeric film in a patternwise fashion using an uppermost relief surface of one or more flexographic printing members to form multiple patterns of the photocurable composition directly on the continuous flexible solid polymeric film during relative movement of the continuous flexible solid polymeric film and the uppermost relief surface of the one or more flexographic printing members to each other in the roll-to-roll process,
wherein the photocurable composition comprises an N-oxyazinium salt photoinitiator, a photosensitizer for the N-oxyazinium salt, an organic phosphite N-oxyazinium salt efficiency amplifier, aromatic heterocyclic nitrogen-containing base, a metal seed catalyst for copper electroless plating in an amount of at least 0.5 weight % based on the total weight of the photocurable composition, and one or more photocurable acrylates in an amount of at least 50 weight % based on the total weight of the photocurable composition, and
the N-oxyazinium salt photoinitiator is present in an amount of at least 0.1 weight % and up to and including 20 weight %, the photosensitizer for the N-oxyazinium salt is present in an amount of at least 0.001 weight % and up to and including 5 weight %, the organic phosphite N-oxyazinium salt efficiency amplifier is present in an amount of at least 0.1 weight % and up to and including 20 weight %, and the aromatic heterocyclic nitrogen-containing base is present in an amount of at least 0.1 weight % and up to and including 20 weight %, all based on the total weight of the one or more photocurable acrylates,
exposing the multiple patterns of the photocurable composition directly on the product substrate to photocuring electromagnetic radiation to form multiple photocured patterns directly on the product substrate in the roll-to-roll process, and
electrolessly plating the multiple photocured patterns directly on the product substrate with copper to form multiple copper electrolessly plated patterns on the product substrate in the roll-to-roll process, each copper electrolessly plated pattern having an average copper line width of less than 15 μm.

2. The method of claim 1, wherein the photocurable composition further comprises an inert organic solvent.

3. The method of claim 1, wherein the exposing is carried out in the presence of oxygen.

4. The method of claim 1, wherein the exposing is carried out using radiation having a wavelength of at least 300 nm and up to and including 450 nm.

5. The method of claim 1 wherein the organic phosphite has the formula:
(R′O)₃P
wherein the multiple R′ groups are the same or different alkyl groups or hydrogen atoms, or two R′ groups can form a cyclic aliphatic ring or fused ring system; or the organic phosphite is chosen from trimethyl phosphite, triethyl phosphite, tripropyl phosphite, tributyl phosphite, triisobutyl phosphite, triamyl phosphite, trihexyl phosphite, trinonyl phosphite, tri-(ethylene glycol) phosphite, tri-(propylene glycol) phosphite, tri(isopropylene glycol) phosphite, tri-(butylene glycol) phosphite, tri-(isobutylene glycol) phosphite, tri-(pentylene glycol) phosphite, tri-(hexylene glycol) phosphite, tri-(nonylene glycol) phosphite, tri-(diethylene glycol) phosphite, tri-(triethylene glycol) phosphite, tri-(polyethylene glycol) phosphite, tri-(polypropylene glycol) phosphite, and tri-(polybutylene glycol) phosphite.

6. The method of claim 1, wherein the N-oxyazinium salt photoinitiator is represented by the following Structure (I) or (II): 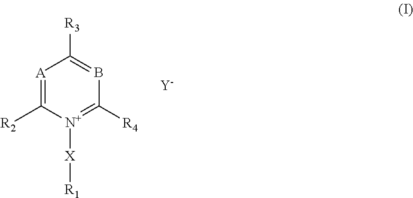
wherein A and B in Structure (I) independently represent a carbon, C—R₅, C—R₆ or nitrogen, X is O, R₁, R₂, R₃, R₄, R₅, and R₆ are independently hydrogen, or alkyl or aryl groups, any of the A, B, and R groups where chemically feasible can be joined to form a ring, and Y is a charge balancing anion that can be a separate moiety or part of an A, B, or R, 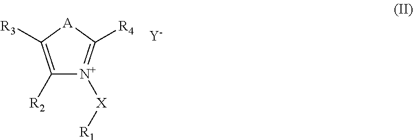
wherein A in Structure (II) represents a carbon, C—R₅, nitrogen, sulfur or oxygen atom with sufficient bonds and substituents to form a heteroaromatic ring, X is O, R₁, R₂, R₃, R₄, and R₅ are independently hydrogen, or alkyl or aryl groups, or any two R groups may form a ring, and Y is a charge balancing anion that can be a separate moiety or part of an R group.

7. The method of claim 1, wherein the N-oxyazinium salt photoinitiator has a reduction potential less negative than −1.4 V and comprises an N-oxy group that is capable of releasing an oxy radical during irradiation of the photocurable composition.

8. The method of claim 1, wherein the photocurable composition comprises the N-oxyazinium salt photoinitiator in an amount of at least 0.1 weight % and up to and including 5 weight % based on the total weight of the one or more photocurable acrylates.

9. The method of claim 1, wherein the photosensitizer is present in the photocurable composition in an amount of at least 0.005 weight % and up to and including 2 weight % based on the total weight of the one or more photocurable acrylates.

10. The method of claim 1, wherein the metal seed material for copper electroless plating comprises platinum, palladium, or silver.

11. The method of claim 1, wherein the photocurable composition is applied to the product substrate to form each of the multiple patterns by contact with the one or more flexographic printing members for at least 10 milliseconds and up to 60 seconds.

12. The method of claim 1, wherein the aromatic heterocyclic nitrogen-containing base is a non-polymeric pyridine, quinoline, isoquinoline, imidazole, benzimidazole, benzthiazole, thiazole, oxazole, benzoxazole, 4,4′-bipyridine, pyrazine, triazine, pyrimidine, nicotinic acid, or isonicotinic acid.

13. The method of claim 1, wherein the aromatic heterocyclic nitrogen-containing base is a pyridine, imidazole, or thiazole.

14. The method of claim 1, comprising forming multiple patterns on opposing sides of the product substrate using one or more flexographic printing plates.

15. The method of claim 1, wherein the product substrate is a continuous flexible solid transparent polyester film.

16. The method of claim 1, further comprising forming one or more electrically-conductive articles containing one or more of the multiple copper electrolessly plated patterns.

17. The method of claim 16, further comprising assembling the one or more electrically-conductive articles into the same or different electronic devices.

18. The method of claim 17, wherein the one or more electrically-conductive articles form individual touch screen displays in the same or different electronic devices.

19. The method of claim 1, wherein:
the one or more photocurable acrylates are present in the photocurable composition in a total amount of at least 60 weight % and up to and including 90 weight %, based on the total weight of the photocurable composition,
the N-oxyazinium salt photoinitiator is present in the photocurable composition in an amount of at least 0.5 weight % and up to and including 2 weight %, based on the total weight of one or more photocurable acrylates,
the photosensitizer is present in the photocurable composition in an amount of at least 0.01 weight % and up to and including 1 weight %, based on the total weight of the one or more photocurable acrylates,
the organic phosphite efficiency amplifier is present in the photocurable composition in an amount of at least 0.5 weight % and up to and including 2 weight %, based on the total weight of the one or more photocurable acrylates, and
the aromatic heterocyclic nitrogen-containing base is present in an amount of at least 0.5 weight % and up to and including 2 weight %, based on the total weight of the one or more photocurable acrylates.
